(19) United States
(12) Patent Application Publication
(10) Pub. No.: US 2012/0016575 A1
(43) Pub. Date: Jan. 19, 2012

(54) System and Method for Providing Fuel Information for Aircraft

(76) Inventor: Thomas White, Huntington, NY (US)

(21) Appl. No.: 12/961,016

(22) Filed: Dec. 6, 2010

Related U.S. Application Data
(60) Provisional application No. 61/266,621, filed on Dec. 4, 2009.

(51) Int. Cl. G06F 19/00

(52) U.S. Cl. 701/123

(57) ABSTRACT

A system and method for determining an expected fuel usage for a flight segment. The system and method including receiving current parameters for a departing airport and an arriving airport for a flight segment of an aircraft, comparing the current parameters to a compilation of historical parameters to determine the historical parameters that correlate to the current parameters, determining an off-to-on time for the flight segment based on the historical parameters and determining an expected fuel usage for the flight segment based on the off-to-on time.

### PRIORITY CLAIM/INCORPORATION BY REFERENCE

This application claims priority to U.S. Provisional Application Ser. No. 61/266,621 entitled “System and Method for Providing Fuel Information for Aircraft” that was filed on Dec. 4, 2009 and names Thomas White as inventor. The entirety of that application is hereby expressly incorporated by reference into this application.

### BACKGROUND

One of the major costs of operating an aircraft is fuel costs. Providing owners/operators of aircraft with expected fuel usage for various flight segments would allow these entities to more effectively allocate their resources. For example, forward looking estimates of fuel usage may be used by owners/operators to negotiate better deals with fuel suppliers at various airport locations. In addition, this would further allow owners/operators to have additional certainty as to their costs for various flight segments meaning that ticket prices may reflect actual costs.

### SUMMARY

A method for receiving current parameters for a departing airport and an arriving airport for a flight segment of an aircraft, comparing the current parameters to a compilation of historical parameters to determine the historical parameters that correlate to the current parameters, determining an off-to-on time for the flight segment based on the historical parameters and determining an expected fuel usage for the flight segment based on the off-to-on time.

A system having a data receiving arrangement receiving current parameters for a departing airport and an arriving airport for a flight segment of an aircraft and a processor comparing the current parameters to a compilation of historical parameters to determine the historical parameters that correlate to the current parameters, the processor further determining an expected fuel usage for the flight segment based on the historical parameters correlated to the current parameters.

A system having a memory storing a set of instructions executable by a processor. The set of instructions being operable to receive current parameters for a departing airport and an arriving airport for a flight segment of an aircraft, compare the current parameters to a compilation of historical parameters to determine the historical parameters that correlate to the current parameters, determine an off-to-on time for the flight segment based on the historical parameters and determine an expected fuel usage for the flight segment based on the off-to-on time.

### BRIEF DESCRIPTION OF DRAWINGS

FIG. 1 shows an exemplary system for providing fuel information for aircraft.

FIG. 2 shows an exemplary embodiment of the fuel advisor.

FIG. 3 shows an example of a database of the fuel advisor correlating historical data to off-to-on times.

FIG. 4 provides an exemplary method for determining the expected fuel usage for a flight segment.

### DETAILED DESCRIPTION

The exemplary embodiments may be further understood with reference to the following description and appended drawings, wherein like elements are referred to with the same reference numerals. The exemplary embodiments provide systems and methods for providing information to determine fuel requirements for a flight segment.

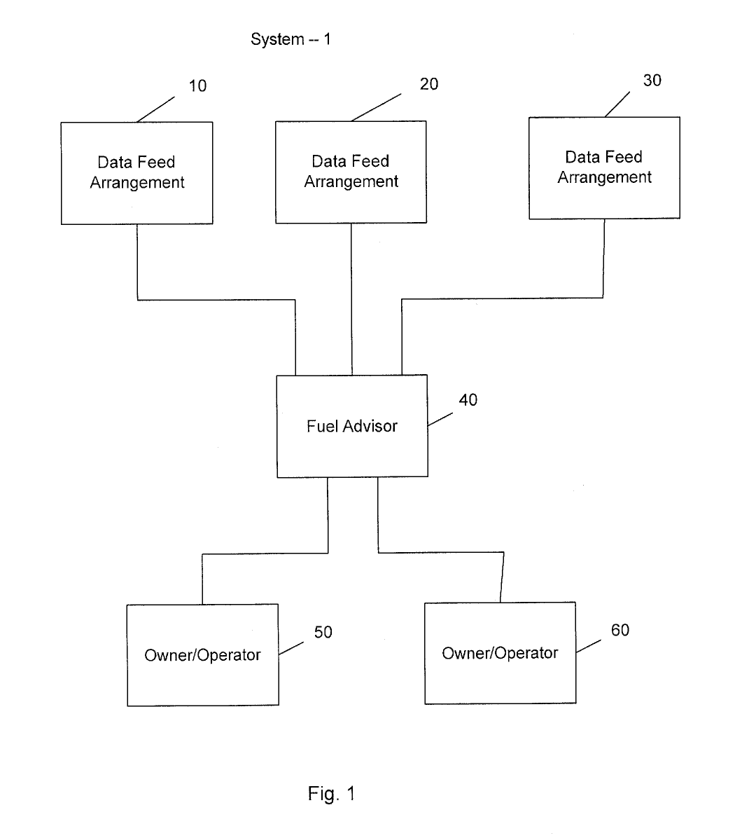

FIG. 1 shows an exemplary system 1 for providing fuel information for aircraft. The exemplary system includes three data feed arrangements 10-30. These data feed arrangements 10-30 provide data to a fuel advisor 40. Examples of the data provided by the data feed arrangements 10-30 to the fuel advisor 40 will be described in greater detail below. The fuel advisor 40 may use this input data along with saved data and/or additional data provided by the owner/operators 50-60 to determine the expected fuel use for various flight segments. The fuel advisor 40 will then provide this information to the owner/operators 50-60 for their use. The operation of each of the components of the system 1 will be described in greater detail below.

The data feed arrangements 10-30 may be any system that provides the data as will be described below. This may include government data feeds such as FAA data feeds, National Weather Service feeds, etc. Other types of data feeds may be third-party private data feeds, airport specific data feeds, owner/operator data feeds, etc. It is noted that the source of the data is not relevant to the exemplary embodiments. In addition, the illustration of three data feed arrangements 10-30 is only exemplary. There may be less or more data feed arrangements providing data to the fuel advisor 40.

The data received by the fuel advisor 40 from the data feed arrangements 10-30 is current information relating to the national airspace system (NAS). Examples of this information may include weather information, runway configurations at various airports, etc. As described above, this information may come from a variety of information sources. In addition, to the current NAS information, the fuel advisor 40 may also store historical NAS information. This historical NAS information (e.g., weather and runway configurations) may be correlated by the fuel advisor 40 to “off-to-on” times for various flight segments. “Off” times refer to the time that an aircraft's wheels leave the ground (wheels-up) and “on” times refer to the time that an aircraft's wheels touch the ground (wheels-down). Thus, the off-to-on time is essentially the amount of time that the aircraft is actually in the air.

Thus, in its simplest form, the fuel advisor 40 may use the current NAS information for a flight segment to determine the expected fuel use for the flight segment. To provide an example, the fuel advisor 40 may have historical information that indicates a flight from John F. Kennedy International Airport in New York (JFK) to Chicago O'Hare International Airport (ORD) with each airport having a defined runway configuration under clear weather conditions has an off-to-on time of 1:10 (one hour ten minutes). The fuel advisor 40 may use this information to determine the expected fuel usage for a current flight from JFK to ORD when the current NAS information matches this historical information. The fuel advisor 40 may then provide this expected fuel use for the flight segment to the owner/operators 50-60. As will be described in greater detail below, there may be additional data that the fuel advisor 40 may consider to refine the expected fuel use calculation. However, the off-to-on time for the flight segment is generally the most important factor for determining fuel use.

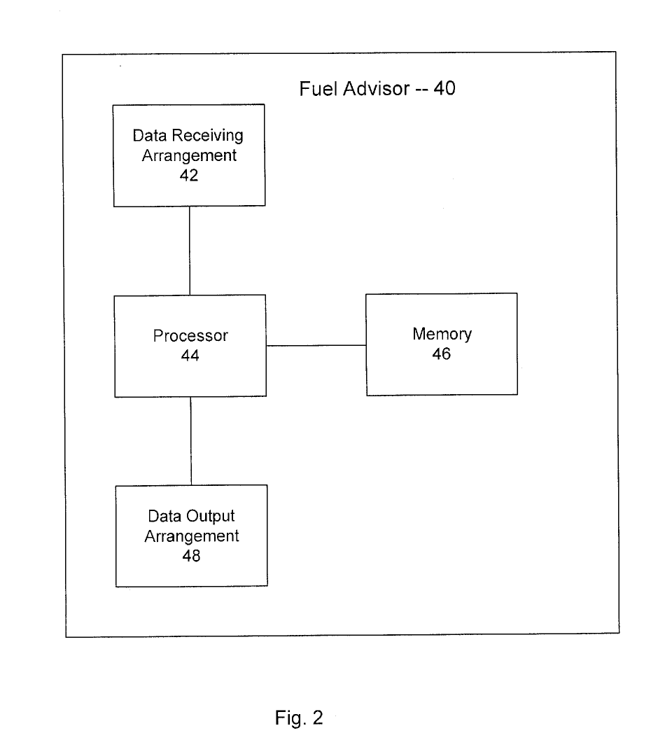

FIG. 2 shows an exemplary embodiment of the fuel advisor 40. This exemplary embodiment of the fuel advisor 40 includes a data receiving arrangement 42, a processor 44, a memory 46 and a data output arrangement 48. In one exemplary embodiment, the fuel advisor 40 and its associated components 42-48 may be embodied in a server device. The data receiving arrangement 42 is configured to receive the data from the data feed arrangements 10-30, but may also be configured to receive other input data from, for example, the owner/operators 50-60 as will be described in greater detail below. This data is provided to the processor 44 to be used to determine the expected fuel use in conjunction with the data stored in memory 46. The determination of the expected fuel use by the processor 44 may be based on the processor 44 executing instructions of a computer program stored in memory 46. The data such as the historical data and the correlated data described above may be stored in a database in memory 46, but other data storage arrangements may also be used. When the processor 44 has calculated the expected fuel use, this information may be provided to the data output arrangement 48 which is configured to output the expected fuel use to the owner/operators 50-60. The embodiment of a server is only exemplary and those skilled in the art will understand that the functionality described herein for the fuel advisor 40 may be included in any type of computing device and that the functionality may be distributed to multiple devices.

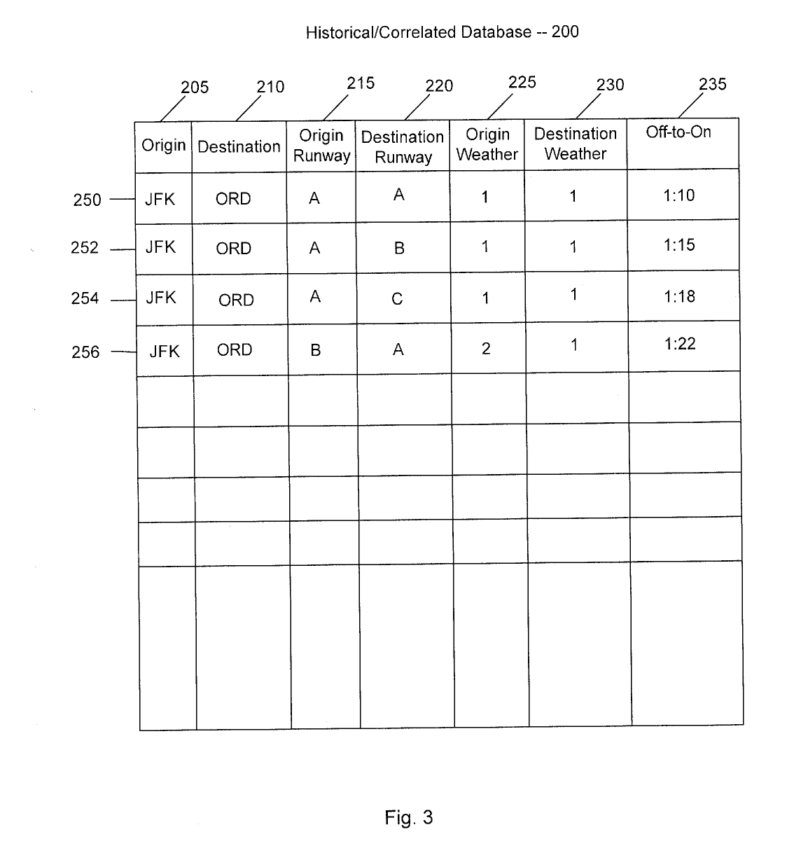

FIG. 3 shows an example of a database 200 of the fuel advisor 40 correlating historical data to off-to-on times. In this example, only several entries 250-256 are shown in table form. In an actual database, there would be hundreds or thousands of entries depending on the number of airports that the fuel advisor 40 was servicing. Those skilled in the art will understand that any particular database may be arranged and stored based on the expected output data. For example, if a particular implementation of a fuel advisor 40 is expected to be used only for flight segments that originate from a single airport, then the database 200 may be limited to entries having that particular airport as an origin and all the possible destination airports from that airport. In another example, the implementation of the fuel advisor 40 may be for a particular owner/operator and therefore, the origin and destination airports may be limited to the airports that owner/operator services.

Referring to FIG. 3, each database entry includes an origin airport 205, a destination airport 210, a runway configuration at the origin airport 215, a runway configuration at the destination airport 220, origin weather 225, destination weather 230 and the correlated off-to-on time 235. The first entry 250 is the entry that corresponds to the example provided above. Specifically, the origin airport 205 is JFK and the destination airport 210 is ORD. A fictitious JFK runaway configuration 215 is labeled as A and the runway configuration 220 at ORD is also labeled as A. The origin weather is categorized as a 1 and the destination weather is also categorized as a 1. For all these conditions, the off-to-on time is 1:10 as was described in the above example. It is noted that the use of A, B, C for runway configurations is only exemplary and there may be many ways to categorize runway configurations. In fact, airports usually have a specific designation for particular runway configurations. Similarly, the use of 1, 2, etc. as weather categories are only exemplary. Other designations may also be used.

The remaining sample entries 252-256 have various changed parameters that result in varying off-to-on times. Thus, it should be apparent to one skilled in the art that if the fuel advisor 40 were to receive current NAS data that corresponded to the data shown in entry 252 for a flight segment from JFK to ORD, the fuel advisor 40 would determine that the off-to-on time for the flight segment would be 1:15.

The fuel advisor 40 may collect NAS data to populate the database 200 for the purpose of the correlation or it may initially be deployed with a pre-populated database 200 for the purpose of correlation. In addition, it is noted that the entries 250-256 may be an average of many flights over a pre-determined time period that meet the parameters. However, as conditions change, the database 200 may be updated either manually or through a learning algorithm. For example, as shown in FIG. 3, the database 200 is currently populated with data for entry 254 showing that under the parameters as defined in the entry, the off-to-on time is 1:18. However, after collecting additional data from the data feed arrangements 10-30, the fuel advisor 40 may determine that the data is tending toward indicating an off-to-on time of 1:27 for this segment under those parameters. The database 200 may automatically alter the correlated off-to-on time based on this trend. Those skilled in the art will understand that the trend may occur for any variety of reasons, e.g., flight paths at one of the airports for a particular runway may have been altered resulting in longer routes, etc. Thus, the fuel advisor 40 may learn this from the trending of the historical data and update the database 200 as needed. However, as described above, a user of the fuel advisor 40 may be alerted to the altered flight paths and what the impact will be and therefore, the user may manually alter the database 200 as needed. Appropriate protection (e.g., challenge password) may be applied to the database 200 to prevent malicious tampering. In addition, prior to automatic altering of a correlation by the fuel advisor 40, the user may be prompted to confirm any changes.

As described above, the off-to-on time information is generally the most important factor in expected fuel usage. Thus, after the fuel advisor 40 determines the off-to-on time based on the current NAS data and comparing it to the historical data, the fuel advisor 40 may output the expected fuel use for the segment to the owner/operator 50-60. In such a case, the database 200 may have another column for each entry that includes the expected fuel use estimate for the off-to-on time 235. This information may also be stored in a different database that merely correlates off-to-on times to expected fuel use. For example, an off-to-on time of 1:20 minutes should have the same fuel use, whether the aircraft is flying from JFK to ORD or JFK to Charlotte. Thus, after the fuel advisor 40 determines the off-to-on time, the fuel advisor 40 may then refer to this other database to determine the expected fuel use and output this information to the owner/operators 50-60.

However, the fuel advisor 40 may include additional data or receive additional data that may be used to further refine the expected fuel use. In a first example, the owner/operator 50-60 may input a request for a particular flight segment that includes an indication of the type of aircraft that will be used to fly the segment. The fuel advisor 40 may include more specific fuel use estimates based on aircraft types and off-to-on times. Thus, the fuel advisor 40 may provide a better estimate based on this additional information. In general, the more information that is provided to the fuel advisor 40, the likelier it is that the output fuel use estimate is more accurate.

In another example, the fuel advisor 40 may include information that correlates runway configurations with taxi and wait times at a particular airport and the fuel advisor 40 may use this additional information to provide a more detailed fuel use estimate. In a further example, the taxi and wait times may be specific to a particular owner/operator experience at an airport (e.g., based on the gates that the owner/operator uses). The information stored by the fuel advisor 40 may also be specific to a time of day for an airport. That is, an aircraft arriving or departing an airport at 9:00 am may experience different circumstances than an aircraft arriving or departing at the same airport at 10:00 pm. The fuel advisor 40 may include additional data to provide fuel estimates for these differing circumstances. Those skilled in the art will understand that there may be many types of data that may be used to refine the fuel use estimates and the above are only examples.

In one example, an owner/operator 50 may input a flight schedule that includes all the flight segments the owner/operator 50 may fly on a particular day. The fuel advisor 40 may calculate the fuel use estimate for all the segments and provide this information to the owner/operator 50. This estimate may be provided as an overall estimate or broken down as requested by the owner/operator 50 (e.g., by airport, by aircraft type, by region, etc.). In addition to being used for planning purposes, the owner/operator may also use this data to compare to its actual usage and then determine if there has been a large variance and the reasons for such variance.

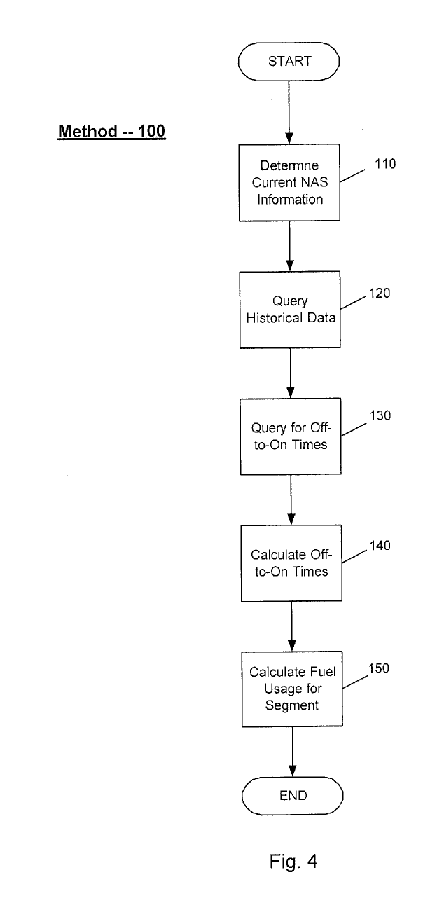

FIG. 4 provides an exemplary method 100 for determining the expected fuel usage for a flight segment. In this example, it will be considered that an owner/operator 50 desires to know the amount of fuel to be used on a flight segment from JFK to ORD. In step 110, the fuel advisor 40 will query the data arrangements 10-30 for the current NAS information for the departing airport (JFK) and the arriving airport (ORD). As described above, this NAS information may be a variety of types of information, but in this example, it will be considered that the information received is weather information and runway configuration. It should also be noted that the fuel advisor 40 may not perform an actual query of the data feed arrangements 10-30, but rather the fuel advisor 40 may receive data from the data feed arrangements 10-30 and buffer this data until it is needed.

In step 120, the fuel advisor 40 will query the stored historical information in, for example, the database 200, to determine an entry that matches the currently determined weather and runway configurations at JFK and ORD. As described above, each entry in the database 200 is generally an average of many flights having the same parameters. Thus, the fuel advisor 40 will determine the entry that most closely matches the parameters, which it has received. It should be noted that throughout this description, it has been assumed that the queries are performed on a database structure that has been populated with appropriate data. However, those skilled in the art will understand that other types of searches may be performed using other methods of storing the types of data described herein.

In step 130, the fuel advisor 40 will query the historical data associated with the similar parameters determined in step 120 to determine the off-to-on times. As described above, this may be generic data or it may be more in depth and based on additional information to which the fuel advisor 40 may have access. In a first example, the owner/operator may be flying a Boeing 737 aircraft today on the JFK-ORD flight segment. Thus, the query executed in step 130 of the determined historical day may be directed to the off-to-on time for Boeing 737 aircraft. In another example, the query may be narrowed to Boeing 737 aircraft for the particular owner/operator. In a broader example, the owner/operator may desire to know the average off-to-on time for all types of aircraft for flight segments having the particular parameters. Thus, as can be seen from the above examples, the owner/operator may modify the query based on any number of variables to obtain the historical off-to-on times.

In step 140, the fuel advisor 40 calculates the off-to-on time for the current day's flight segment from JFK-ORD. This calculation step may be as simple as taking the off-to-on times determined in step 130 or may include additional calculations. For example, the fuel advisor 40 may have received additional information such as en route weather information (e.g., a storm in the Cleveland area) and it may use this data to supplement the time determined in step 130 to calculate the off-to-on time in step 140.

At the completion of step 140, the fuel advisor 40 will have determined the calculation of the off-to-on time for the flight segment and the fuel advisor 40 may use this information to provide an estimate of the fuel usage for the current day's flight segment in step 150. As described above, once the fuel advisor 40 has the off-to-on time, the fuel advisor 40 may further include the fuel burn for the particular aircraft and may then calculate the fuel usage for the flight time. However, the additional steps described above and/or below may also be used to further refine the flight segment fuel usage calculation.

In another refinement example, the fuel advisor 40 may further include historical fuel used data from the owner/operator that may be used to refine the calculation. For example, the owner/operator may input the actual fuel usage for flight segments into the fuel advisor 40. This fuel usage data may include aircraft type, flight segment, weather conditions, aircraft loading, flight time, etc. This historical fuel usage data may also be taken into account when the fuel advisor 40 calculates the fuel usage for the current day's flight.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
receiving current parameters for a departing airport and an arriving airport for a flight segment of an aircraft;
comparing the current parameters to a compilation of historical parameters to determine the historical parameters that correlate to the current parameters;
determining an off-to-on time for the flight segment based on the historical parameters; and
determining an expected fuel usage for the flight segment based on the off-to-on time.

2. The method of claim 1, wherein the current parameters include a runway configuration and a weather pattern.

3. The method of claim 1, wherein the compilation of historical parameters includes data for a plurality of flight segments having parameters that are substantially the same.

4. The method of claim 1, further comprising:
receiving additional information related to the flight segment, wherein the determination of the off-to-on time is further based on the additional information.

5. The method of claim 1, further comprising:
altering the compilation of historical parameters based on receiving additional historical parameters.

6. The method of claim 1, wherein determining the expected fuel usage includes calculating a fuel usage.

7. The method of claim 1, further comprising:
receiving an indication of a type of the aircraft, wherein the determining the expected fuel usage is further based on the type of the aircraft.

8. The method of claim 1, further comprising:
receiving an indication of one of a taxi time and a wait time for one of the departing airport or arriving airport, wherein the determining the expected fuel usage is further based on the one of the taxi time and wait time.

9. A system, comprising:
a data receiving arrangement receiving current parameters for a departing airport and an arriving airport for a flight segment of an aircraft;
a processor comparing the current parameters to a compilation of historical parameters to determine the historical parameters that correlate to the current parameters, the processor further determining an expected fuel usage for the flight segment based on the historical parameters correlated to the current parameters.

10. The system of claim 9, wherein the processor determines an off-to-on time for the flight segment based on the historical parameters, the expected fuel usage being based on the off-to-on time.

11. The system of claim 9, further comprising:
a memory storing the compilation of historical parameters.

12. The system of claim 9, further comprising:
a data output arrangement outputting the expected fuels usage.

13. The system of claim 9, wherein the current parameters include a runway configuration and a weather pattern.

14. The system of claim 11, wherein the memory stores the compilation of historical parameters including data for a plurality of flight segments having parameters that are substantially the same.

15. The system of claim 10, wherein the data receiving arrangement receives additional information related to the flight segment, wherein the processor determines the off-to-on time further based on the additional information.

16. The system of claim 9, wherein the processor alters the compilation of historical parameters based on receiving additional historical parameters.

17. The system of claim 9, wherein the data receiving arrangement further receives an indication of a type of the aircraft, wherein the processor determines the expected fuel usage based further on the type of the aircraft.

18. The system of claim 9, wherein the data receiving arrangement further receives an indication of one of a taxi time and a wait time for one of the departing airport or arriving airport, wherein the processor determines the expected fuel usage based further on the one of the taxi time and wait time.

19. A system comprising a memory storing a set of instructions executable by a processor, the set of instructions being operable to:
receive current parameters for a departing airport and an arriving airport for a flight segment of an aircraft;
compare the current parameters to a compilation of historical parameters to determine the historical parameters that correlate to the current parameters;
determine an off-to-on time for the flight segment based on the historical parameters; and
determine an expected fuel usage for the flight segment based on the off-to-on time.
